(19) United States
(12) Patent Application Publication
(10) Pub. No.: US 2013/0034722 A1
(43) Pub. Date: Feb. 7, 2013

(54) SOL-GEL BASED ANTIREFLECTIVE COATINGS USING PARTICLE-BINDER APPROACH WITH HIGH DURABILITY, MOISTURE RESISTANCE, CLOSED PORE STRUCTURE AND CONTROLLABLE PORE SIZE

(71) Applicants: Nikhil D. Kalyankar, Hayward, CA (US); Nitin Kumar, Fremont, CA (US)

(72) Inventors: Nikhil D. Kalyankar, Hayward, CA (US); Nitin Kumar, Fremont, CA (US)

(73) Assignee: INTERMOLECULAR, INC., San Jose, CA (US)

(21) Appl. No.: 13/195,119

(22) Filed: Aug. 1, 2011

(51) Int. Cl. B05D 5/06; G02B 5/22

(52) U.S. Cl. 428/317.5; 427/162; 252/589

(57) ABSTRACT

Durable porous low refractive index coatings, methods and compositions for forming the porous low refractive index coatings are provided. The method comprises coating a substrate with a sol formulation comprising a silane-based binder having one or more reactive groups and silica based nanoparticles and annealing the coated substrate. The silane-based binder comprises from about 30 wt. % to about 70 wt. % ash contribution in the total ash content of the sol formulation. Porous coatings formed according to the embodiments described herein demonstrate good optical properties (e.g., a low refractive index) while maintaining good mechanical durability due to the presence of a high amount of binder and a closed pore structure.

### BACKGROUND OF THE INVENTION

1. Field of the Invention

Embodiments of the invention relate generally to porous low refractive index (RI) anti-reflective coatings, methods and compositions for forming the porous low RI anti-reflective coatings on substrates.

2. Description of the Related Art

Coatings that provide low reflectivity or a high percent transmission over a broad wavelength range of light are desirable in many applications including semiconductor device manufacturing, solar cell manufacturing, glass manufacturing, and energy cell manufacturing. The transmission of light through a material causes the wavelength of the light to change, a process known as refraction, while the frequency remains unchanged thus changing the speed of light in the material. The refractive index of a material is a measure of the speed of light in that material which is generally expressed as a ratio of the speed of light in vacuum relative to that in the material. Low reflectivity coatings generally have an optimized refractive index (n) in between air (n=1) and glass (n˜1.5).

An antireflective (AR) coating is a type of low reflectivity coating applied to the surface of a transparent article to reduce reflectance of visible light from the article and enhance the transmission of such light into or through the article thus decreasing the refractive index. One method for decreasing the refractive index and enhancing the transmission of light through an AR coating is to increase the porosity of the antireflective coating. Porosity is a measure of the void spaces in a material. Although such antireflective coatings have been generally effective in providing reduced reflectivity over the visible spectrum, the coatings have suffered from deficiencies when used in certain applications. For example, it is often difficult to control pore size and shape. Further, porous AR coatings which are used in solar applications are highly susceptible to moisture absorption. Moisture absorption may lead to an increase in refractive index of the AR coating and corresponding reduction in light transmission.

Thus, there is a need for low refractive index AR coatings which exhibit increased durability and controllable pore size.

### SUMMARY OF THE INVENTION

Embodiments of the invention relate generally to porous low refractive index (RI) anti-reflective coatings, methods and compositions for forming the porous low RI anti-reflective coatings on substrates. In one embodiment, a method of forming a porous coating on a substrate is provided. The method comprises coating a substrate with a sol formulation comprising a silane-based binder having one or more reactive groups and silica based nanoparticles and annealing the coated substrate. The silane-based binder comprises from about 30 wt. % to about 70 wt. % ash contribution in the total ash content of the sol formulation.

In another embodiment, a porous coating is provided. The porous coating is formed by the process of coating a substrate with a sol-formulation comprising a silane-based binder having one or more reactive groups and silica based nanoparticles and forming a porous coating by annealing the coated substrate. A silica contribution from the silane-based binder comprises from about 30 wt. % to about 70 wt. % of the porous coating. In certain embodiments, the porous coating has a pore fraction of between about 0.3 and 0.6. In certain embodiments, the porous coating has a refractive index of 1.30 or less.

In yet another embodiment, a sol-formulation for forming a sol-gel is provided. The sol-formulation comprises an alcohol containing solvent, an acid or base containing catalyst, tetraethylorthosilicate (TEOS) binder, and silica nanoparticles, wherein the mass ratio of TEOS to silica nanoparticles in the sol-formulation is between 60:40 and 90:10.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow chart of one embodiment of a method for forming a low refractive index porous coating on a substrate according to embodiments described herein;

FIG. 2 is a plot depicting the theoretical effect of increasing the silica binder ash percent contribution relative to silica particle ash percent contribution on the refractive index of an anti-reflective coating;

FIG. 3 is a plot depicting the effect of increasing the silica binder ash % contribution relative to the silica particle ash % contribution on the refractive index of an anti-reflective coating formed according to embodiments described herein;

FIG. 4 is a plot depicting the refractive index verses the binder ash percent contribution for various anti-reflective coatings formed according to the embodiments described herein;

FIG. 5 is a schematic diagram illustrating one embodiment of a porous coating on a glass substrate according to embodiments described herein; and

FIG. 6 is a schematic diagram illustrating one embodiment of a photovoltaic cell comprising a porous coating according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention relate generally to porous low refractive index (RI) anti-reflective coatings, methods and compositions for forming the porous low RI anti-reflective coatings on substrates. More specifically, embodiments of the invention relate generally to sol-gel processes and sol-formulations for forming low refractive index coatings on substrates.

The term “binder” as used herein refers to a component used to bind together one or more types of materials in mixtures. The principal properties of a binder are adhesion and cohesion.

The term “porosity” as used herein is a measure of the void spaces in a material, and may be expressed as a fraction, the “pore fraction” of the volume of voids over the total volume, between 0 and 1, or as a percentage between 0 to 100%.

The term “sol-formulation” as used herein is a chemical solution comprising at least a silane based binder and silica based nanoparticles.

The term “sol-gel process” as used herein is a process where a wet formulation (the “sol”) is dried to form a gel coating having both liquid and solid characteristics. The gel coating is then heat treated to form a solid material. This technique is valuable for the development of coatings because it is easy to implement and provides films of uniform composition and thickness.

The term “sol-gel transition point” as used herein refers to the point of transition of a sol to a gel.

The term “solidifier” as used herein refers to any chemical compound that expedites the occurrence of the sol-gel transition point. It is believed that the solidifier increases the viscosity of the sol to form a gel.

The term “surfactant” as used herein is an organic compound that lowers the surface tension of a liquid and contains both hydrophobic groups and hydrophilic groups. Thus the surfactant contains both a water insoluble component and a water soluble component. The surfactant may also be used to stabilize colloidal sols to reduce the precipitation of solids over extended periods of storage.

The term “total ash content” as used herein refers to the amount of inorganic components remaining after combustion of the organic matter in the sol-formulation by subjecting the sol-formulation to high temperatures. Exemplary inorganic materials remaining after combustion of the organic matter for a sol-formulation described herein typically include silica from particles and silica from binder. However, other inorganic materials, for example, fluorine, may also be present in the total ash content after combustion. The “total ash content” is typically obtained by the following method:

1. Exposing a known quantity of a sol-formulation to high temperatures greater than 600 degrees Celsius to combust the organic matter.

2. Weighing the leftover inorganic material (referred to as “ash”).

The total ash content is calculated from the following formula: total ash content (wt. %) of the sol-formulation=(Weight of ash (g)/original weight of the sol-formulation (g))×100.

The term “binder ash percent contribution” refers to the percentage of ash in the total ash content coming from binder. The binder levels specified herein are typically described in terms of “equivalent weight of silica” contribution to total ash content of the formulation. For example, a 70% binder ash contribution would mean 70% of the total ash content in the formulation comes from silica-based binder and 30% of the total ash content comes from silica based nanoparticles.

Certain embodiments described herein relate to a wet chemical film deposition process using a specific sol-formulation including at least one silane-based binder and silica based nanoparticles to produce porous anti-reflective coatings with a low refractive index (e.g., lower than glass). Typically, an increase in the binder present in a sol-formulation would lead to a reduction in pore fraction and a corresponding increase in the refractive index of the resulting anti-reflective coating. However, for the sol-formulations and resulting anti-reflective coatings described herein, the refractive index unexpectedly decreases between 25% binder ash percent contribution and 70% binder ash percent contribution as a function of increasing binder amount. In addition to the ratio of silane-based binder to silica based nanoparticles, specific combinations of particle size and shape are also believed to contribute to the decrease in refractive index. The resulting porous anti-reflective coatings may also exhibit high durability and a closed pore structure.

The low refractive index porous coatings formed by sol-gel processes described herein may be further developed using combinatorial methods of optimizing the sol-formulations and conditions used to create those coatings. Combinatorial methods may include any processing that varies the processing conditions in two or more substrates or regions of a substrate. The combinatorial methodology includes multiple levels of screening to select coatings for further variation and optimization. Exemplary combinatorial methods and apparatus are described in co-pending U.S. patent application Ser. No. 12/970,638, filed Dec. 16, 2010 and titled HIGH-THROUGHPUT COMBINATORIAL DIP-COATING APPARATUS AND METHODOLOGIES.

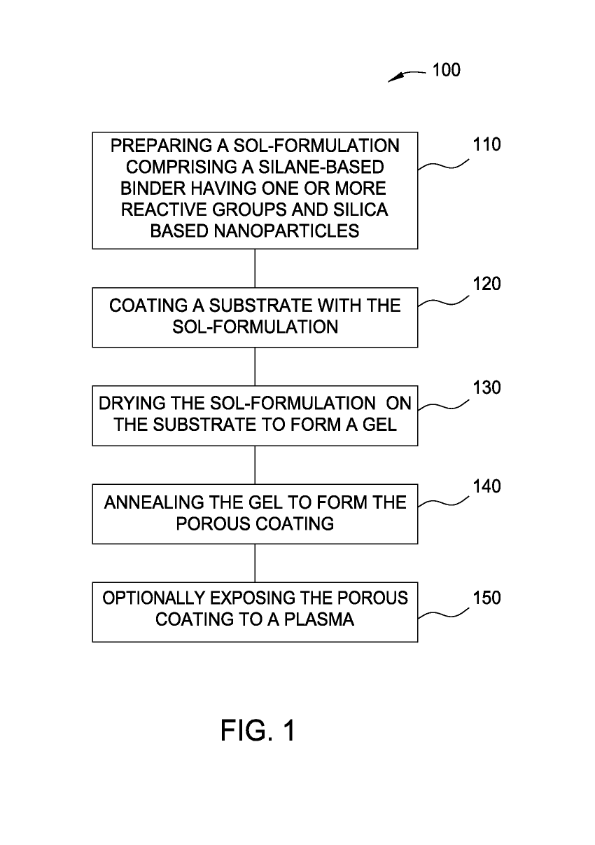

FIG. 1 is a flow chart of one embodiment of a method 100 for forming a low refractive index porous coating on a substrate according to embodiments described herein. At block 110, a sol-formulation comprising a silane-based binder having one or more reactive groups and silica based nanoparticles is prepared.

In one embodiment, the sol-formulation may be prepared by mixing a silane-based binder, silica based nanoparticles, an acid or base containing catalyst and a solvent system. The sol-formulation may be formed by at least one of a hydrolysis and polycondensation reaction. The sol-formulation may be stirred at room temperature or at an elevated temperature (e.g., 50-60 degrees Celsius) until the sol-formulation is substantially in equilibrium (e.g., for a period of 24 hours). The sol-formulation may then be cooled and additional solvents added to either reduce or increase the ash content if desired.

In one embodiment, the silane-based binder comprises a silane containing molecule having one or more reactive groups. The silane-based binder may have two or more reactive groups. The silane-based binder may have three or more reactive groups. The silane-based binder may have four or more reactive groups. Exemplary silanes may be selected from the group consisting of tetraethylorthosilicate (TEOS), tetramethylorthosilicate, (TMOS), tetrapropylorthosilicate, methyltriethoxysilane (MTES), methylpropoxysilane, methyltrimethoxysilane (MTMS), glycidoxipropyltrimethoxysilane (Glymo), 1,2-ethylenebis(trimethoxysilane), N-butyltrimethoxysilane, tetrabutylorthosilicate, aminoethyltrimethoxysilane, trimethoxysilane, triethoxysilane, vinyltrimethoxysilane, tetrakis(trimethylsilyloxy)silane, propyltriethoxysilane (PTES), tetrapropylorthosilicate (TPOS), ethyltriethyoxysilane (ETES), and combinations thereof.

The amount of silane-based binder in the sol-formulation may comprise at least 0.1 wt. %, 1 wt. %, 5 wt. %, 7 wt. %, 9 wt. %, 10 wt. %, 12 wt. %, 15 wt. %, 20 wt. %, 25 wt. %, 30 wt. %, 35 wt. %, 40 wt. %, or 45 wt. % of the total weight of the sol-formulation. The amount of silane-based binder in the sol-formulation may comprise up to 1 wt. %, 5 wt. %, 7 wt. %, 9 wt. %, 10 wt. %, 12 wt. %, 15 wt. %, 20 wt. %, 25 wt. %, 30 wt. %, 35 wt. %, 40 wt. %, or 45 wt. % or 50 wt. % of the total weight of the sol-formulation. The amount of the silane-based binder in the sol-formulation may be present in the sol-formulation in an amount between about 0.1 wt. % and about 50 wt. % of the total weight of the sol-formulation. The amount of the silane-based binder in the sol-formulation may be present in the sol-formulation in an amount between about 5 wt. % and about 12 wt. % of the total weight of the sol-formulation.

The total ash content of the sol-formulation may vary from 0.05% to 20% by mass of the sol-formulation. The total ash content of the sol-formulation may comprise at least 0.05%, 1%, 3%, 4%, 5%, 7%, 9%, 11%, 13%, 15%, 17%, or 19% by mass of the sol-formulation. The total ash content of the sol-formulation may comprise up to 1%, 3%, 4%, 5%, 7%, 9%, 11%, 13%, 15%, 17%, 19%, or 20% by mass of the sol-formulation.

The ash percent contribution of the silane-based binder to the total ash content in the sol-formulation may comprise at least 25 wt. %, 30 wt. %, 35 wt. %, 40 wt. %, 45 wt. %, 50 wt. %, 55 wt. %, 60 wt. %, or 65 wt. % of the total ash content of the sol-formulation. The ash percent contribution of the silane-based binder in the sol-formulation may comprise up to 30 wt. %, 35 wt. %, 40 wt. %, 45 wt. %, 50 wt. %, 55 wt. %, 60 wt. %, 65 wt. %, or 70 wt. % of the total ash content in the sol-formulation. The ash percent contribution of the silane-based binder to the total ash content in the sol-formulation may be present in an amount between about 25 wt. % and about 70 wt. % of the total ash content in the sol-formulation. The ash percent contribution of silane-based binder to the total ash content in the sol-formulation may be present in the sol-formulation in an amount between about 60 wt. % and about 70 wt. % of the total ash content in the sol-formulation.

The silica based nanoparticles may be spherical or non-spherical (e.g., elongated, pearl-shaped, or disc-shaped). The silica based nanoparticles include silica based nanoparticles with at least one dimension between 10 and 200 nanometers. The silica based nanoparticles may be selected from spherical particles having a particle size from about 40 to 50 nm, spherical particles having a particle size from about 70 to 100 nm, spherical particles having a particle size from about 10 to 15 nm, spherical particles having a particle size from about 17 to 23 nm, elongated particles having a diameter from 9 to 15 nm and length of 40 to 100 nm, and combinations thereof.

The silica based nanoparticles may be colloidal silica mono-dispersed in an organic solvent. Exemplary organic solvents include N,N-Dimethyl acetamide, ethylene glycol, isopropanol, methanol, methyl ethyl ketone, methyl isobutyl ketone, and methanol. The amount of silica based nanoparticles present in the organic solvent may comprise between 15 wt. % and 45 wt. % of the total colloidal silica in organic solvent system. The colloidal silica in organic solvent system may comprise less than 3.0% water. The colloidal silica in organic solvent may have a viscosity less than 100 mPa·s. The colloidal silica in organic solvent may have a pH from about 2 to about 6.

Exemplary silica based nanoparticles are available from Nissan Chemical America Corporation under the tradename ORGANOSILICASOL™. Suitable commercially available products of that type include ORGANOSILICASOL™ IPA-ST silica particles (particle size of 10-15 nm, 30-31 wt. % of SiO₂), ORGANOSILICASOL™ IPA-ST-L silica particles (particle size of 40-50 nm, 30-31 wt. % of SiO₂), ORGANOSILICASOL™ IPA-ST-MS silica particles (particle size of 17-23 nm, 30-31 wt. % of SiO₂), ORGANOSILICASOL™ IPA-ST-UP silica particles (particles have a diameter of 9-15 nm with a length of 40-100 nm, 15-16 wt. % of SiO₂), and ORGANOSILICASOL™ IPA-ST-ZL silica particles (particle size of 70-100 nm, 30-31 wt. % of SiO2).

Other exemplary silica based nanoparticles are available from Nissan Chemical America Corporation under the tradename SNOWTEX® colloidal silica. Suitable commercially available products of that type include SNOWTEX® ST-20L colloidal silica (particle size of 40-50 nm, 20-21 wt. % of SiO₂), SNOWTEX® ST-40 colloidal silica (particle size of 10-20 nm, 40-41 wt. % of SiO₂), SNOWTEX® ST-50 colloidal silica (particle size of 20-30 nm, 47-49 wt. % of SiO₂), SNOWTEX® ST-C colloidal silica (particle size of 10-20 nm, 20-21 wt. % of SiO₂), SNOWTEX® ST-N colloidal silica (particle size of 10-20 nm, 20-21 wt. % of SiO₂), SNOWTEX® ST-O colloidal silica (particle size of 10-20 nm, 20-21 wt. % of SiO₂), SNOWTEX® ST-OL colloidal silica (particle size of 40-50 nm, 20-21 wt. % of SiO₂), SNOWTEX® ST-ZL colloidal silica (particle size of 70-100 nm, 40-41 wt. % of SiO₂), SNOWTEX® ST-PS-M colloidal silica (particle size of 18-25 nm/80-150 nm, <0.2 wt. % of SiO₂), SNOWTEX® ST-PS-MO colloidal silica (particle size of 18-25 nm/80-150 nm, 18-19 wt. % of SiO₂), SNOWTEX® ST-PS-S colloidal silica (particle size of 10-15 nm/80-120 nm, 15-16 wt. % of SiO₂), SNOWTEX® ST-PS-0 colloidal silica (particle size of 10-15 nm/80-120 nm, 15-16 wt. % of SiO₂), SNOWTEX® ST-OUP colloidal silica (particle size of 9-15 nm/40-100, 15-16 wt. % of SiO₂), and SNOWTEX® ST-UP colloidal silica (particle size of 9-15 nm/40-100 nm, <0.2 wt. % of SiO₂).

Other exemplary silica based nanoparticles are available from Nippon Shokubai Co. Ltd. under the tradename SEAHOSTAR® spherical silica particles. Suitable commercially available products of that type include SEAHOSTAR® type KE amorphous silica particles such as: SEAHOSTAR® type KE-E10 amorphous silica particles (average particle size of 0.10 μm-0.16 μm), SEAHOSTAR® type KE-W10 amorphous silica particles (average particle size of 0.09 μm-0.15 μm), and SEAHOSTAR® type KE-P10 amorphous silica particles (average particle size of 0.08 μm-0.14 μm),

Other exemplary silica-based nanoparticles are available from Purest Colloids, Inc. under the tradename MesoSilica™ nanoparticle colloidal silica (average particle size of 6 nm) and from Rockwood Additives Ltd. under the tradename LAPONITE® silica particles.

The amount of silica based nanoparticles in the sol-formulation may comprise at least 0.01 wt. %, 0.05 wt. %, 1 wt. %, 1.5 wt. %, 2 wt. %, 2.5 wt. %, 3 wt. %., 3.5 wt. %, 5 wt. %, 7 wt. %, 9 wt. %, 11 wt. %, or 13 wt. % of the total weight of the sol-formulation. The amount of silica based nanoparticles in the sol-formulation may comprise up to 0.05 wt. %, 1 wt. %, 1.5 wt. %, 2 wt. %, 2.5 wt. %, 3 wt. %., 3.5 wt. %, 5 wt. %, 7 wt. %, 9 wt. %, 11 wt. %, 13 wt. %, or 15 wt. % of the total weight of the sol-formulation. The amount of the silica based nanoparticles in the sol-formulation may be present in the sol-formulation in an amount between about 0.01 wt. % and about 15 wt. % of the total weight of the sol-formulation. The amount of the silica based nanoparticles in the sol-formulation may be present in the sol-formulation in an amount between about 1.5 wt. % and about 3.5 wt. % of the total weight of the sol-formulation.

The ash percent contribution of the silica based nanoparticles to the total ash content in the sol-formulation may comprise at least 25 wt. %, 30 wt. %, 35 wt. %, 40 wt. %, 45 wt. %, 50 wt. %, 55 wt. %, 60 wt. %, or 65 wt. % of the total ash content of the sol-formulation. The ash percent contribution of silica based nanoparticles in the sol-formulation may comprise up to 30 wt. %, 35 wt. %, 40 wt. %, 45 wt. %, 50 wt. %, 55 wt. %, 60 wt. %, 65 wt. %, or 70 wt. % of the total ash content of the sol-formulation. The ash percent contribution of silica based nanoparticles in the sol-formulation may be present in an amount between about 25 wt. % and about 70 wt. % of the total ash content of the sol-formulation. The ash percent contribution of silica based nanoparticles in the sol-formulation may be present in an amount between about 30 wt. % and about 40 wt. % of the total ash content of the sol-formulation.

A mass ratio of the silane-based binder to silica based nanoparticles in the sol-formulation may be between 60:40 and 90:10. Exemplary ratios of the silane-based binder to the silica based nanoparticles include 60:40, 70:30, 80:20, 85:15, and 90:10.

The sol-formulation may further include an acid or base catalyst for controlling the rates of hydrolysis and condensation. The acid or base catalyst may be an inorganic or organic acid or base catalyst. Exemplary acid catalysts may be selected from the group consisting of hydrochloric acid (HCl), nitric acid (HNO₃), sulfuric acid (H₂SO₄), acetic acid (CH₃COOH), formic acid (HCO₂H), phosphoric acid (H₃PO₄), glycolic acid, citric acid, and combinations thereof. Exemplary base catalysts include ammonium hydroxide, tetramethylammonium hydroxide (TMAH), sodium hydroxide (NaOH), potassium hydroxide (KOH), and the like.

The acid catalyst level may be 0.001 to 10 times in stoichiometric amount compared with the silane-based binder. The acid catalyst level may be from 0.001 wt. % to 0.1 wt. % of the total weight of the sol-formulation. The base catalyst level may be from 0.001 to 10 times molar binder (the silane-based binder). The base catalyst level may be from 0.001 wt. % to 0.1 wt. % of the total weight of the sol-formulation.

The sol-formulation further includes a solvent system. The solvent system may include a non-polar solvent, a polar aprotic solvent, a polar protic solvent, and combinations thereof. Selection of the solvent system and the porosity forming agent may be used to influence the formation and size of pores. Exemplary solvents include alcohols, for example, n-butanol, isopropanol, n-propanol, ethanol, methanol, and other well known alcohols. The amount of solvent may be from 80 wt. % to 95 wt. % of the total weight of the sol-formulation.

The solvent system may further include water. Water may be present in 0.5 to 10 times in stoichiometric amount compared with the silane-based binder. Water may be present from 0.001 to 0.1 wt. % of the total weight of sol-formulation.

The sol-formulation may further include a surfactant. In certain embodiments, the surfactant may be used for stabilizing the sol-gel composition. In certain embodiments, the surfactant may be used as a molecular porogen which is used as a porosity forming agent. The surfactant may be selected from the group comprising: non-ionic surfactants, cationic surfactants, anionic surfactants, and combinations thereof. Exemplary non-ionic surfactants include non-ionic surfactants with linear hydrocarbon chains and non-ionic surfactants with hydrophobic trisiloxane groups. The surfactant may be a trisiloxane surfactant. Exemplary molecular porogens may be selected from the group consisting of: polyoxyethylene stearyl ether, benzoalkoniumchloride (BAC), cetyltrimethylammoniumbromide (CTAB), 3-glycidoxypropyltrimethoxysilane, polyethyleneglycol (PEG), ammonium lauryl sulfate (ALS), dodecyltrimethylammoniumchloride (DTAC), polyalkyleneoxide modified hepta-methyltrisiloxane, and combinations thereof.

Exemplary surfactants are commercially available from Momentive Performance Materials under the tradename SILWET® surfactant and from SIGMA ALDRICH® under the tradename BRIJ® surfactant. Suitable commercially available products of that type include SILWET® L-77 surfactant and BRIJ® 78 surfactant.

In certain embodiments, where the surfactant is used as a stabilizer, the surfactant may be present in the sol-formulation in an amount between about 0.0001% and about 0.003 wt. % of the total weight of the sol-formulation.

In certain embodiments, where the surfactant is used as a molecular porogen, the molecular porogen may be present in the sol-formulation in an amount between about 0.1 and about 5 wt. % of the total weight of the sol-formulation.

The sol-formulation may further include a gelling agent or “solidifier”. The “solidifier” may be used to expedite the occurrence of the sol-gel transition point. It is believed that the solidifier increases the viscosity of the sol to form a gel.

The solidifier may be selected from the group comprising: gelatin, polymers, silica gel, emulsifiers, organometallic complexes, charge neutralizers, cellulose derivatives, and combinations thereof.

Gelatin is generally a translucent, colorless, brittle solid derived from the hydrolysis of collagen by boiling skin, ligaments and tendons. Exemplary gelatins are commercially available from SIGMA-ALDRICH®.

The polymers may be selected from the group comprising: sodium acrylate, sodium acryloyldimethyl taurate, isohexadecane, polyoxyethylene (80) sorbitan monooleate (commercially available under the tradename TWEEN® 80 from ICI Americas Inc.), polyoxyethylene (20) sorbitan monostearate (commercially available under the tradename TWEEN® 60 from ICI Americas Inc.), laureth-7, C13-14 Isoparaffin, hydroxyethyl acrylate, polyacrylamide, polyvinyl butyral (PVB), squalane, polyalkylene glycols, and combinations thereof. Exemplary polymers are available under the tradenames SIMULGEL® 600, SIMULGEL® EG, SEPIGEL® 305, SIMULGEL® NS, CAPIGEL™ 98, SEPIPLUS™ 265 and SEPIPLUS™ 400 all of which are commercially available from SEPPIC.

Exemplary polyalkylene glycols include polyalkylene glycols where the alkyl group may be any alkyl group, such as, methyl, ethyl, propyl, butyl, pentyl, hexyl, heptyl, octyl, nonyl, decyl, etc. One exemplary polyalkylene glycol includes polyethylene glycol (PEG). Preferable polyethylene glycols have a molecular mass between 200 and 1,000.

Silica gel is a granular, viscous, highly porous form of silica made synthetically from sodium silicate. Exemplary silica gels are commercially available from SIGMA-ALDRICH®.

Exemplary organometallic complexes may comprise a hydrophilic sugar-like head portion and a lipophilic hydrocarbon tail couple by an organometallic fragment (e.g., pentacarbonyl[D-gluco-hex (N-n-octylamino)-1-ylidene]chromium). Other exemplary organometallic complexes include low-molecular mass organic gelator (LMOG).

Exemplary charge neutralizers include ammonium nitrate, sodium chloride, ammonium chloride, and other salts.

Exemplary cellulose derivatives include hydroxypropyl cellulose (HPC), hydroxypropyl methylcellulose (HPMC), nitrocellulose, hydroxypropyl ethylcellulose, hydroxypropyl butylcellulose, hydroxypropyl pentylcellulose, methyl cellulose, ethylcellulose, hydroxyethyl cellulose, various alkyl celluloses and hydroxyalkyl celluloses, various cellulose ethers, cellulose acetate, carboxymethyl cellulose, sodium carboxymethyl cellulose, calcium carboxymethyl cellulose, among others. Exemplary cellulose derivatives are commercially available under the tradenames KLUCEL® hydroxypropylcellulose, METHOCEL™ cellulose ethers, and ETHOCEL™ ethylcellulose polymers.

The at least one solidifier may comprise at least 0.0001 wt. %, 0.001 wt. %, 0.01 wt. %, 0.1 wt. % or 1 wt. % of the sol-formulation. The at least one solidifier may comprise up to 0.01 wt. %, 0.1 wt. %, 1 wt. % or 5 wt. % of the sol-formulation. In certain embodiments, the at least one solidifier may comprise between 0.001 wt. % and 1 wt % of the sol-formulation. It should be understood that the amount of solidifier added to the sol-gel composition may be based on factors including molecular weight, reactivity, and the number of reactive sites per molecule all of which may vary from molecule to molecule. It is preferable to lower the percent solids at the sol-gel transition point; while at the same time assuring that the solidifier doesn't induce gelation prior to coating in the liquid phase itself.

At block 120, a substrate is coated with the sol-formulation. Exemplary substrates include glass, silicon, metallic coated materials, or plastics. The substrate may be a transparent substrate. The substrate may be flat, curved or any other shape as necessary for the application under consideration. The substrate may be textured or patterned. Exemplary glass substrates include high transmission low iron glass, borosilicate glass (BSG), sodalime glass and standard clear glass. The sol-gel composition may be coated on the substrate using, for example, dip-coating, spin coating, curtain coating, roll coating, capillary coating or a spray coating process. Other application methods known to those skilled in the art may also be used. The substrate may be coated on a single side or on multiple sides of the substrate.

At block 130, the coating on the substrate is dried to form a gel. A gel is a coating that has both liquid and solid characteristics and may exhibit an organized material structure (e.g., a water based gel is JELL-O®). During the drying, the solvent of the sol-formulation is evaporated and further bonds between the components, or precursor molecules, may be formed. The drying may be performed by exposing the coating on the substrate to the atmosphere at room temperature. The coatings (and/or the substrates) may alternatively be exposed to a heated environment at a boiling point above the solvent, low pressure regions, or heated or room temperature air flow to elevate the rate of solvent evaporation. The drying of the coating may not require elevated temperatures, but may vary depending on the composition of the sol-formulation used to form the coating. In one embodiment, the drying temperature may be in the range of approximately 25 degrees Celsius to approximately 200 degrees Celsius. In one embodiment, the drying temperature may be in the range of approximately 50 degrees Celsius to approximately 60 degrees Celsius. The drying process may be performed for a time period of between about 1 minute and 10 minutes, for example, about 6 minutes. Drying temperature and time are dependent on the boiling point of the solvent used during sol formation.

At block 140, the gel is annealed to form the porous coating. The annealing temperature and time may be selected based on the chemical composition of the sol-formulation, depending on what temperatures may be required to form cross-linking between the components throughout the coating. In one embodiment, the annealing temperature may be in the range of 500 degrees Celsius and 1,000 degrees Celsius. In one embodiment, the annealing temperature may be 600 degrees Celsius or greater. In another embodiment, the annealing temperature may be between 625 degrees Celsius and 650 degrees Celsius. The annealing process may be performed for a time period of between about 3 minutes and 1 hour, for example, about 6 minutes.

The porous coating layer in one embodiment may have a thickness greater than 50 nanometers. The porous coating layer in another embodiment may have a thickness between about 50 nanometers and about 1,000 nanometers. The porous coating layer in yet another embodiment may have a thickness between about 100 nanometers and about 200 nanometers. The porous coating layer in still yet another embodiment may have a thickness of about 150 nanometers.

The pores of the porous coating may on average be between about 2 nm and about 10 nm. The pores of the porous coating may on average of between about 2 nanometers and about 3 nanometers. The porous coating may have a pore fraction of between about 0.3 and about 0.6. The porous coating may have a porosity of between about 20% and about 60% as compared to a solid film formed from the same material.

The silica contribution of the silane-based binder to the porous coating may comprise at least 25 wt. %, 30 wt. %, 35 wt. %, 40 wt. %, 45 wt. %, 50 wt. %, 55 wt. %, 60 wt. %, or 65 wt. % of the porous coating. The silica contribution of the silane-based binder to the porous coating may comprise up to 30 wt. %, 35 wt. %, 40 wt. %, 45 wt. %, 50 wt. %, 55 wt. %, 60 wt. %, 65 wt. %, or 70 wt. % of the porous coating. The silica contribution of the silane-based binder to the porous coating may be between about 30 wt. % and about 70 wt. % of the porous coating. The silica contribution of silane-based binder to the porous coating may be between about 60 wt. % and about 70 wt. % of the porous coating.

The silica based nanoparticles may comprise at least 25 wt. %, 30 wt. %, 35 wt. %, 40 wt. %, 45 wt. %, 50 wt. %, 55 wt. %, 60 wt. %, or 65 wt. % of the porous coating. The silica based nanoparticles may comprise up to 30 wt. %, 35 wt. %, 40 wt. %, 45 wt. %, 50 wt. %, 55 wt. %, 60 wt. %, 65 wt. %, or 70 wt. % of the porous coating. The silica based nanoparticles may be present in an amount between about 30 wt. % and about 70 wt. % of the porous coating. The silica based nanoparticles may be present in an amount between about 30 wt. % and about 40 wt. % of the porous coating.

In one embodiment, the porous coating may be a single coating. In alternate embodiments, the coating may be formed of multiple coatings on the same substrate. In such an embodiment, the coating, gel-formation, and annealing may be repeated to form a multi-layered coating with any number of layers. The multi-layers may form a coating with graded porosity. For example, in certain embodiments it may be desirable to have a coating which has a higher porosity adjacent to air and a lower porosity adjacent to the substrate surface. A graded coating may be achieved by modifying various parameters, such as, the type of porosity forming agent, the anneal time, and the anneal temperature.

At block 150, the porous coating may be exposed to plasma to seal the top layer of the pores to make the film more moisture resistant while preserving the optical properties of the film. The plasma may be RF or DC plasma. In certain embodiments, the pores may be sealed using a molecular masking layer. One exemplary masking layer includes a polymeric layer which may be a few nanometers thick and doesn't significantly impact the overall refractive index of the film. Another exemplary masking layer could be a vacuum deposited metal oxide layer of 2-5 nanometers thickness such as TiO₂.

### EXAMPLES

It is believed that the following examples further illustrate the objects and advantages of the embodiments. The particular materials and amounts thereof, as well as other conditions and details, recited in these examples should not be used to limit embodiments described herein. Unless stated otherwise all percentages, parts and ratios are by weight. Examples of the invention are numbered while comparative samples, which are not examples of the invention, are designated alphabetically.

### Example #1

A sol-formulation was prepared using Tetraethylorthosilicate (TEOS) as the binder, n-propanol as the solvent, acetic acid as the catalyst, ORGANOSILICASOL™ IPA-ST-UP elongated silica particles, and water. The total ash content of the solution was 4% (based on equivalent weight of SiO₂ produced). The ratio of silane-based binder to silica particles (TEOS:IPA-ST-UP particles) was 50:50 ash content contribution. TEOS and silica particles were mixed with water (2 times the molar TEOS amount), acetic acid (5 times the molar TEOS amount) and n-propanol. The solution was stirred for 24 hours at room temperature.

### Example #2

A sol-formulation was prepared using Tetraethylorthosilicate (TEOS) as the binder, n-propanol as the solvent, acetic acid as the catalyst, ORGANOSILICASOL™ IPA-ST-UP elongated silica particles, and water. The total ash content of the solution was 4% (based on equivalent weight of SiO₂ produced). The ratio of silane-based binder to silica particles (TEOS:IPA-ST-UP particles) was 50:50 ash content contribution. TEOS and silica particles were mixed with water (2 times the molar TEOS amount), acetic acid (5 times the molar TEOS amount) and n-propanol. The solution was mixed at room temperature and stirred for 24 hours at 60 degrees Celsius.

### Example #3

A sol-formulation was prepared using methyltriethoxysilane (MTES) as the binder, n-propanol as the solvent, acetic acid as the catalyst, ORGANOSILICASOL™ IPA-ST-UP elongated silica particles, and water. The total ash content of the solution was 4% (based on equivalent weight of SiO₂ produced). The ratio of silane-based binder to silica particles (MTES:IPA-ST-UP particles) was 50:50 ash content contribution. MTES and silica particles were mixed with water (2 times the molar TEOS amount), acetic acid (5 times the molar MTES amount) and n-propanol. The solution was mixed at room temperature and stirred for 24 hours at 60 degrees Celsius.

### Example #4

A sol-formulation was prepared using methyltriethoxysilane (MTES) as the binder, n-propanol as the solvent, acetic acid as the catalyst, ORGANOSILICASOL™ IPA-ST-UP elongated silica particles, and water. The total ash content of the solution was 4% (based on equivalent weight of SiO₂ produced). The ratio of silane-based binder to silica particles (MTES:IPA-ST-UP particles) was 50:50 ash content contribution. MTES and silica particles were mixed with water (2 times the molar TEOS amount), acetic acid (5 times the molar MTES amount) and n-propanol. The solution was stirred for 24 hours at room temperature.

### Example #5

A sol-formulation was prepared using Tetraethylorthosilicate (TEOS) as the binder, n-propanol as the solvent, acetic acid as the catalyst, ORGANOSILICASOL™ IPA-ST-UP elongated silica particles, and water. The total ash content of the solution was 4% (based on equivalent weight of SiO₂ produced). The ratio of silane-based binder to silica particles (TEOS:IPA-ST-UP particles) was 70:30 ash content contribution. TEOS and silica particles were mixed with water (2 times the molar TEOS amount), acetic acid (5 times the molar TEOS amount) and n-propanol. The solution was stirred for 24 hours at room temperature.

### Example #6

A sol-formulation was prepared using Tetraethylorthosilicate (TEOS) as the binder, n-propanol as the solvent, acetic acid as the catalyst, ORGANOSILICASOL™ IPA-ST-UP elongated silica particles, and water. The total ash content of the solution was 4% (based on equivalent weight of SiO₂ produced). The ratio of silane-based binder to silica particles (TEOS:IPA-ST-UP particles) was 60:40 ash content contribution. TEOS and silica particles were mixed with water (2 times the molar TEOS amount), acetic acid (5 times the molar TEOS amount) and n-propanol. The solution was stirred for 24 hours at room temperature.

### Example #7

A sol-formulation was prepared using Tetraethylorthosilicate (TEOS) as the binder, n-propanol as the solvent, nitric acid as the catalyst, ORGANOSILICASOL™ IPA-ST-UP elongated silica particles, and water. The total ash content of the solution was 4% (based on equivalent weight of SiO₂ produced). The ratio of silane-based binder to silica particles (TEOS:IPA-ST-UP particles) was 50:50 ash content contribution. TEOS and silica particles were mixed with water (2 times the molar TEOS amount), nitric acid (5 times the molar TEOS amount) and n-propanol. The solution was stirred for 24 hours at room temperature.

### Example #8

A sol-formulation was prepared using Tetramethylorthosilicate (TMOS) as the binder, n-butanol as the solvent, nitric acid as the catalyst, ORGANOSILICASOL™ IPA-ST-L spherical silica particles, and water. The total ash content of the solution was 8% (based on equivalent weight of SiO₂ produced). The ratio of silane-based binder to silica particles (TMOS:IPA-ST-L particles) was 40:60 ash content contribution. TMOS and silica particles were mixed with water (10 times the molar TMOS), nitric acid (0.05 times the molar TMOS amount) and n-butanol. The solution was stirred for 24 hours at 60 degrees Celsius.

### Example #9

A sol-formulation was prepared using propyltriethoxysilane (PTES) as the binder, ethanol as the solvent, sulfuric acid as the catalyst, ORGANOSILICASOL™ IPA-ST-MS spherical silica particles, and water. The total ash content of the solution was 6% (based on equivalent weight of SiO₂ produced). The ratio of silane-based binder to silica particles (PTES:IPA-ST-MS particles) was 70:30 ash content contribution. PTES and silica particles were mixed with water (5 times the molar PTES amount), sulfuric acid (0.02 times the molar PTES amount) and ethanol. The solution was stirred for 24 hours at room temperature.

### Example #10

A sol-formulation was prepared using Tetrapropylorthosilicate (TPOS) as the binder, n-butanol as the solvent, formic acid as the catalyst, ORGANOSILICASOL™ IPA-ST-ZL spherical silica particles, and water. The total ash content of the solution was 10% (based on equivalent weight of SiO₂ produced). The ratio of silane-based binder to silica particles (TPOS:IPA-ST-ZL particles) was 40:60 ash content contribution. TPOS and silica particles were mixed with water (6 times the molar TPOS amount), formic acid (0.5 times the molar TPOS amount) and n-butanol. The solution was stirred for 24 hours at room temperature.

### Example #11

A sol-formulation was prepared using ethyltriethoxysilane (ETES) as the binder, ethanol as the solvent, glycolic acid as the catalyst, ORGANOSILICASOL™ IPA-ST-MS spherical silica particles, and water. The total ash content of the solution was 10% (based on equivalent weight of SiO₂ produced). The ratio of silane-based binder to silica particles (ETES:IPA-ST-MS particles) was 50:50 ash content contribution. ETES and silica particles were mixed with water (10 times the molar ETES amount), glycolic acid (1 times the molar ETES amount) and ethanol. The solution was mixed at room temperature and stirred for 24 hours at 60 degrees Celsius.

### Example #12

A sol-formulation was prepared using Tetraethylorthosilicate (TEOS) as the binder, ethanol as the solvent, citric acid as the catalyst, ORGANOSILICASOL™ IPA-ST-MS spherical silica particles, and water. The total ash content of the solution was 8% (based on equivalent weight of SiO₂ produced). The ratio of silane-based binder to silica particles (TEOS:IPA-ST-MS particles) was 55:45 ash content contribution. TEOS and silica nano-particles were mixed with water (4 times the molar TEOS amount), citric acid (0.15 times the molar TEOS amount) and ethanol. The solution was stirred for 24 hours at room temperature.

### Example #13

A sol-formulation was prepared using tetramethylorthosilicate (TMOS) as the binder, ethanol as the solvent, ammonium hydroxide as the catalyst, ORGANOSILICASOL™ IPA-ST-MS spherical silica particles, and water. The total ash content of the solution was 12% (based on equivalent weight of SiO₂ produced). The ratio of silane-based binder to silica particles (TMOS:IPA-ST-MS particles) was 40:60 ash content contribution. TMOS and silica particles were mixed with water (2 times the molar TEOS amount), ammonium hydroxide (0.5 times the molar TMOS amount) and ethanol. The solution was stirred for 24 hours at 60 degrees Celsius.

### Example #14

A sol-formulation was prepared using Tetrapropylorthosilicate (TPOS) as the binder, n-propanol as the solvent, sulfuric acid as the catalyst, ORGANOSILICASOL™ IPA-ST-ZL spherical silica particles, and water. The total ash content of the solution was 3% (based on equivalent weight of SiO₂ produced). The ratio of silane-based binder to silica particles (TPOS:IPA-ST-ZL particles) was 50:50 ash content contribution. TPOS and silica particles were mixed with water (10 times the molar TPOS amount), sulfuric acid (0.05 times the molar TPOS amount) and n-propanol. The solution was stirred for 24 hours at 50 degrees Celsius.

### Example #15

A sol-formulation was prepared using methyltriethoxysilane (MTES) as the binder, ethanol as the solvent, tetramethylammoniumhydroxide (TMAH) as the catalyst, ORGANOSILICASOL™ IPA-ST-UP elongated silica particles, and water. The total ash content of the solution was 10% (based on equivalent weight of SiO₂ produced). The ratio of silane-based binder to silica particles (MTES:IPA-ST-UP particles) was 30:70 ash content contribution. MTES and silica particles were mixed with water (10 times the molar TEOS amount), TMAH (0.5 times the molar MTES amount) and n-propanol. The solution was stirred for 24 hours at 60 degrees Celsius.

### Example #16

A sol-formulation was prepared using Tetraethylorthosilicate (TEOS) as the binder, n-propanol as the solvent, acetic acid as the catalyst, a mixture of ORGANOSILICASOL™ IPA-ST-UP elongated silica particles and IPA-ST-MS (at 67:33 ratio), and water. The total ash content of the solution was 4% (based on equivalent weight of SiO₂ produced). The ratio of silane-based binder to silica nano particles was 50:50 ash content contribution. TEOS and silica particles were mixed with water (2 times the molar TEOS amount), acetic acid (5 times the molar TEOS amount) and n-propanol. The solution was stirred for 24 hours at room temperature.

The aforementioned sol-formulations were deposited using either dip (coating speed ˜10 mm/sec) or spin coating (1,000-1,400 rpm) processes on pre-cleaned borosilicate (BSG) or sodalime glass to achieve a film thickness of around ˜150 nm after annealing. The glass substrate was then dried at 150 degrees Celsius for 30 minutes in an oven to evaporate all the solvent and then annealed at 625-650 degrees Celsius for 6 minutes. The glass substrate was cooled on a steel slab and characterized to determine the film thickness, refractive index (RI) and improvement in transmittance of light.

Results

Table I depicts data for mixed particle sols as described herein that were deposited using a dip coating process. The various sized silica particles are available from Nissan Chemical America Corporation under the tradename ORGANOSILICASOL™ and have been previously described. Sol numbers 1 to 16 were 4% ash sols and Sol numbers 57 to 65 were 3% ash sols. The single particle sols (IPA-ST-ZL 100%) show the lowest RI when compared with other mixed particle sols.

TABLE I

| | Particles at 15% mass | | | | | | Dip |
|---|---|---|---|---|---|---|---|
| Sol | IPA- | IPA- | IPA- | IPA- | IPA- | Sol ash | coating |
| # | ST-UP | ST | ST-L | ST-MS | ST-ZL | content | RI |
| 1 | 100% | 0% | 0% | 0% | 0% | 4% | 1.26 |
| 2 | 0% | 100% | 0% | 0% | 0% | 4% | 1.39 |
| 3 | 0% | 0% | 100% | 0% | 0% | 4% | 1.37 |
| 4 | 0% | 0% | 0% | 100% | 0% | 4% | 1.37 |
| 5 | 33% | 67% | 0% | 0% | 0% | 4% | 1.38 |
| 6 | 67% | 33% | 0% | 0% | 0% | 4% | 1.36 |
| 7 | 0% | 33% | 67% | 0% | 0% | 4% | 1.38 |
| 8 | 0% | 67% | 33% | 0% | 0% | 4% | 1.39 |
| 9 | 0% | 0% | 33% | 67% | 0% | 4% | 1.37 |
| 10 | 0% | 0% | 67% | 33% | 0% | 4% | 1.37 |
| 11 | 33% | 0% | 67% | 0% | 0% | 4% | 1.33 |
| 12 | 67% | 0% | 33% | 0% | 0% | 4% | 1.33 |
| 13 | 0% | 33% | 0% | 67% | 0% | 4% | 1.38 |
| 14 | 0% | 67% | 0% | 33% | 0% | 4% | 1.38 |
| 15 | 33% | 0% | 0% | 67% | 0% | 4% | 1.36 |
| 16 | 67% | 0% | 0% | 33% | 0% | 4% | 1.34 |
| 57 | 0% | 0% | 0% | 0% | 100% | 3% | 1.29 |
| 58 | 0% | 0% | 0% | 33% | 67% | 3% | 1.35 |
| 59 | 0% | 0% | 33% | 0% | 67% | 3% | 1.34 |
| 60 | 0% | 33% | 0% | 0% | 67% | 3% | 1.35 |
| 61 | 33% | 0% | 0% | 0% | 67% | 3% | 1.34 |
| 62 | 0% | 0% | 0% | 67% | 33% | 3% | 1.38 |
| 63 | 0% | 0% | 67% | 0% | 33% | 3% | 1.37 |
| 64 | 0% | 67% | 0% | 0% | 33% | 3% | 1.38 |
| 65 | 67% | 0% | 0% | 0% | 33% | 3% | 1.34 |

Table II depicts the summary experimental data for porous films deposited using a dip coating process according to embodiments described herein. The porous films were deposited using a dip coating process at a dip coating pull speed of 2 mm/seconds followed by annealing at 650 degrees Celsius for 3.5 minutes. There was an unexpected decrease in the refractive index between sol number 68 (approximately 25% binder/75% particle) and sol number 72 (approximately 70% binder/25% particles) as the binder fraction increased and the particle fraction decreased.

TABLE II

| | | | | Sol ash content (total 3%) | | Dip | Estimated film fractions | |
|---|---|---|---|---|---|---|---|---|
| Sol # | Particle name | Particle type | Particle size, nm | Binder fraction | Particle fraction | coating RI | Solid fraction | Void fraction |
| 66 | IPA-ST-ZL | Spherical | 70-100 nm | 0% | 100% | 1.281 | 0.655 | 0.345 |
| 67 | IPA-ST-ZL | Spherical | 70-100 nm | 10% | 90% | 1.290 | 0.674 | 0.326 |
| 68 | IPA-ST-ZL | Spherical | 70-100 nm | 25% | 75% | 1.281 | 0.656 | 0.344 |
| 69 | IPA-ST-ZL | Spherical | 70-100 nm | 35% | 65% | 1.279 | 0.650 | 0.350 |
| 70 | IPA-ST-ZL | Spherical | 70-100 nm | 50% | 50% | 1.269 | 0.629 | 0.371 |
| 71 | IPA-ST-ZL | Spherical | 70-100 nm | 60% | 40% | 1.261 | 0.611 | 0.389 |
| 72 | IPA-ST-ZL | Spherical | 70-100 nm | 70% | 30% | 1.264 | 0.618 | 0.382 |
| 73 | IPA-ST-ZL | Spherical | 70-100 nm | 85% | 15% | 1.284 | 0.662 | 0.338 |
| 74 | IPA-ST-ZL | Spherical | 70-100 nm | 90% | 10% | 1.307 | 0.710 | 0.290 |

Table III depicts the summary experimental data for porous films deposited using a spin coating process according to embodiments described herein. The spin coating processes were performed at spin speeds of 900 rpm, 1,100 rpm, 1,300 rpm, and 1,500 rpm. The refractive index appears to be independent of spin speed at the same binder ash % contribution for elongated particles. However, at higher binder % contribution values for spherical particles, the RI reduces as a function of spin speed.

TABLE III

| | | | | | Sol ash content (total 3%) | | Refractive index | | | |
|---|---|---|---|---|---|---|---|---|---|---|
| Sol # | Particle name | Particle type | Particle size, nm | | Binder fraction | Particle fraction | 900 rpm | 1100 rpm | 1300 rpm | 1500 rpm |
| 39 | IPA-ST-UP | Elongated | 9-15/40-100 | nm | 10% | 90% | 1.22 | 1.21 | 1.21 | 1.21 |
| 40 | IPA-ST-UP | Elongated | 9-15/40-100 | nm | 25% | 75% | 1.27 | 1.27 | 1.27 | 1.27 |
| 43 | IPA-ST-UP | Elongated | 9-15/40-100 | nm | 60% | 40% | 1.34 | 1.34 | 1.34 | 1.34 |
| 44 | IPA-ST-UP | Elongated | 9-15/40-100 | nm | 70% | 30% | 1.34 | 1.34 | 1.33 | 1.34 |
| 67 | IPA-ST-ZL | Spherical | 70-100 | nm | 10% | 90% | 1.25 | 1.24 | 1.25 | 1.24 |
| 68 | IPA-ST-ZL | Spherical | 70-100 | nm | 25% | 75% | 1.26 | 1.27 | 1.26 | 1.27 |
| 71 | IPA-ST-ZL | Spherical | 70-100 | nm | 60% | 40% | 1.30 | 1.27 | 1.26 | 1.24 |
| 72 | IPA-ST-ZL | Spherical | 70-100 | nm | 70% | 30% | 1.23 | 1.25 | 1.21 | 1.21 |

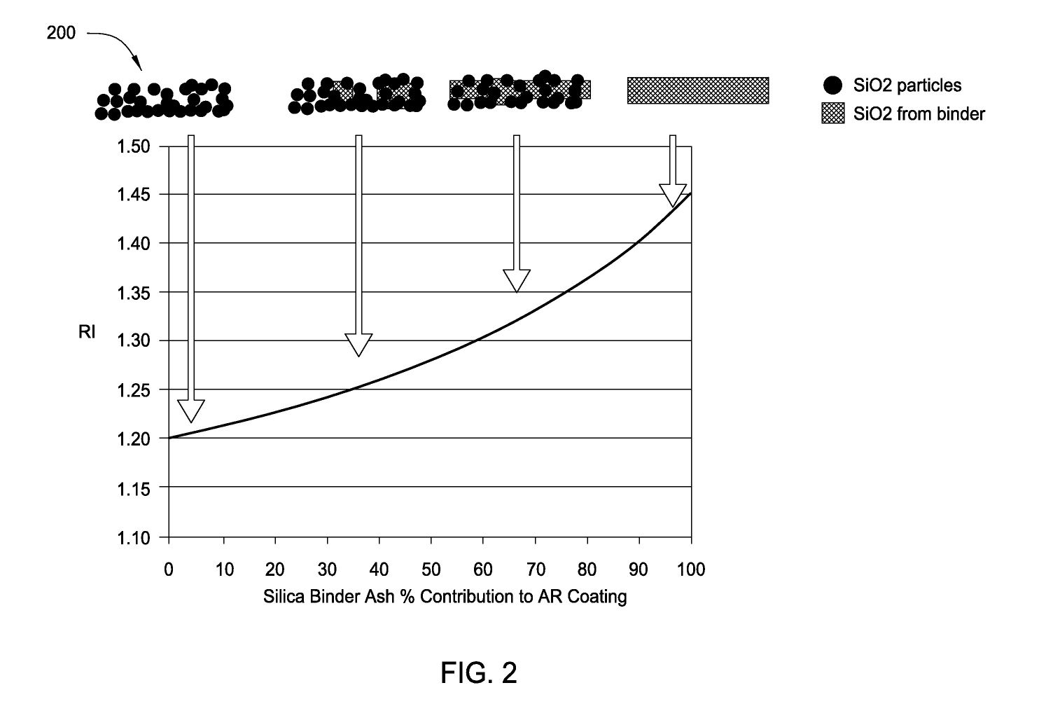

FIG. 2 is a plot 200 depicting the theoretical effect of increasing the silica binder ash percent contribution relative to silica particle ash percent contribution on the refractive index of an anti-reflective coating. The x-axis represents the silica binder ash % contribution to the anti-reflective coating and the y-axis represents the refractive index for the anti-reflective coating. As the percentage of silica from silica binder increased, the coating was modeled to consist of two phases, one with porous silica from particle packing and the other solid silica from binder. As shown in FIG. 2, a coating formed from only ellipsoidal silica particles is shown to give a refractive index of approximately 1.21 whereas a coating formed from only silica binder exhibits a refractive index of 1.45. Based on the theoretical model of FIG. 2 one would predict that the refractive index will increase as the porous silica from silica particles is replaced by “solid” silica from binder.

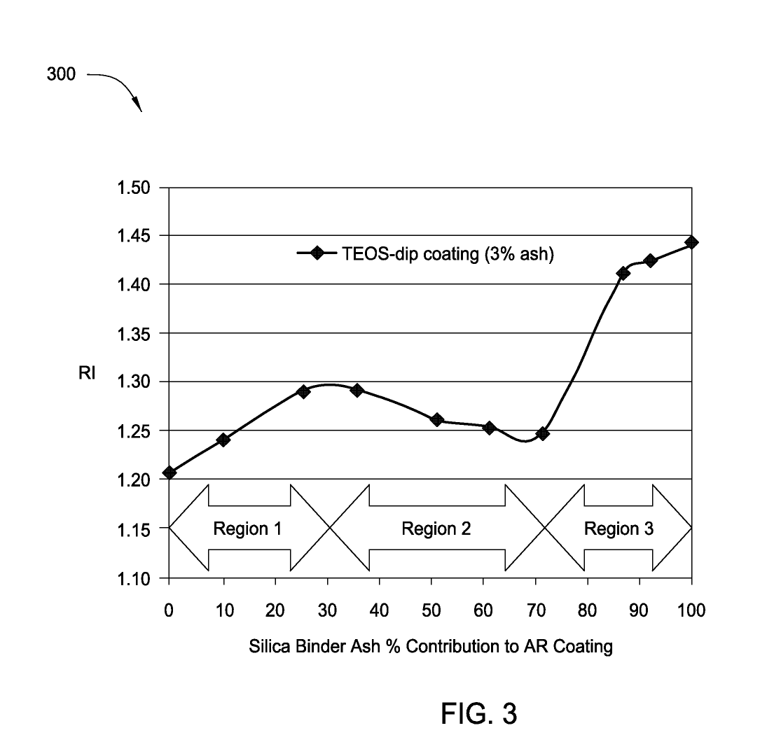

FIG. 3 is a plot 300 depicting the effect of increasing the silica binder ash % contribution relative to the silica particle ash % contribution on the refractive index of an anti-reflective coating formed according to embodiments described herein. The x-axis represents the silica particle ash % contribution from binder and the y-axis represents the refractive index for the anti-reflective coating. FIG. 3 shows the results of dip-coating experiments where the amount of binder was progressively increased from 0 to 100%. The anti-reflective coatings were deposited using a dip-coating process. The plot 300 is divided into three regions. In Region 1, from 0 to 30% silica from binder, the refractive index increased as the percentage of silica from binder increased as predicted by the model of FIG. 2. It is believed that the increase in refractive index in Region 1 is due to the silica binder filing voids created between the silica particle aggregates. In Region 3, from approximately 70% to 100% silica from binder the RI increased sharply to reach 1.45 at 100% silica from binder as predicted by the theoretical model of FIG. 2. It is believed that the sharp increase in refractive index in Region 3 is due to the addition of more “solid” silica from binder which overcomes the effect of the amount of silica coming from silica particle aggregates.

However, contrary to the theoretical model depicted in FIG. 2, in Region 2 of FIG. 3, from approximately 30% to approximately 70% silica from binder, the refractive index unexpectedly decreased as the percentage of silica from binder increased. Not to be bound by theory, but it is believed that as the binder increases in Region 2, the “stickiness” of the silica particles also increases, therefore, as the solvent dries, and the silica particles aggregate, a more open particulate gel network is formed. This more open particulate network survives capillary forces during drying and tempering resulting in lower RI films.

It is believed that the increase in particle “stickiness” is caused by the cross-linking of silanes during solvent drying. Particle stickiness can be described as follows: when two particles under Brownian motion come close to each other, the two particles can stick to each other if the particles have short range attractive interaction, or the two particles can bounce away from each other. With increasing binder fraction, the amount of hydrolyzed silane also increases. During coating formation and drying, the hydrolyzed silanes not only crosslink with each other, but also begin to crosslink with the surface silica groups on the particles. Thus, at higher binder fraction, particles have more crosslinking silane chains on their surface and when the particles come close to each other, the particles are more likely to stick to each other resulting in more open particle aggregate structures and lower RI.

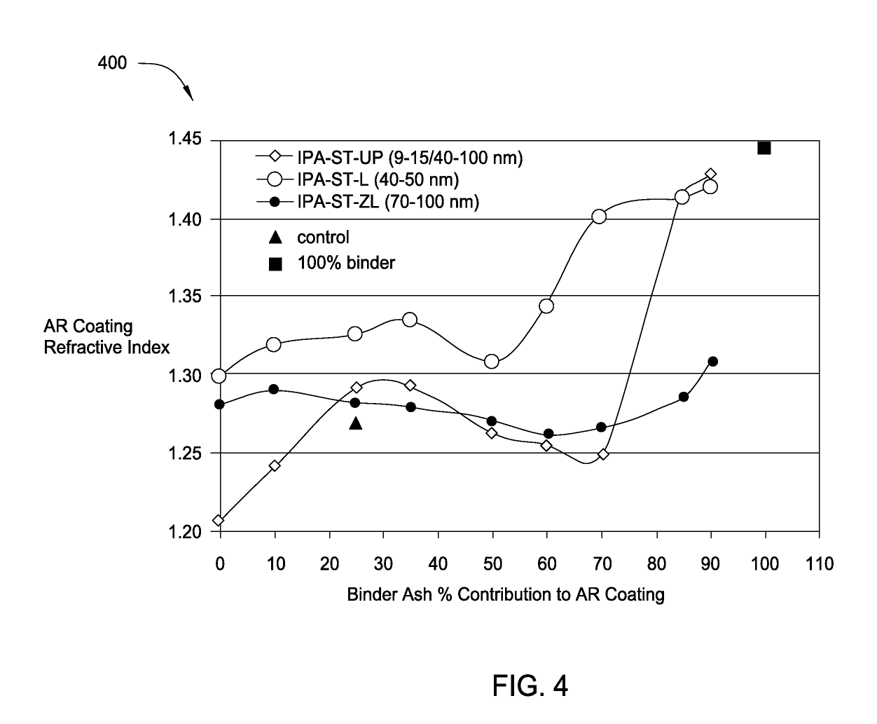

FIG. 4 is a plot 400 depicting the refractive index for an anti-reflective coating verses binder ash percent contribution to the anti-reflective coating for various binder-particle based anti-reflective coatings deposited according to embodiments described herein. The x-axis represents the binder ash % contribution to the anti-reflective coating and the y-axis represents the refractive index for the anti-reflective coating. The various binder-particle based anti-reflective coatings are each based on particles having a different particle size. As previously discussed, an increase in the binder present would typically lead to a reduction in pore fraction and a corresponding increase in the refractive index. However, as shown in FIG. 4, for the anti-reflective coatings described herein, the refractive index unexpectedly decreases between 25% binder ash percent contribution and 70% binder ash percent contribution as a function of increasing binder amount. As shown in FIG. 4, from 1% to approximately 25% SiO₂ from binder, the RI increased, followed by a decrease in RI from approximately 25% to 70% SiO₂ from binder. Then from approximately 70% to 100% SiO₂ from binder, the RI increased sharply to reach a refractive index of approximately 1.45. Thus the RI trend as a function of binder % contribution to ash content for the largest spherical particles (IPA-ST-ZL) is similar to IPA-ST-L (spherical with smaller diameter) and IPA-ST-UP (elongated particle). Larger particle size appears to provide lower RI values at the same binder % ash contribution.

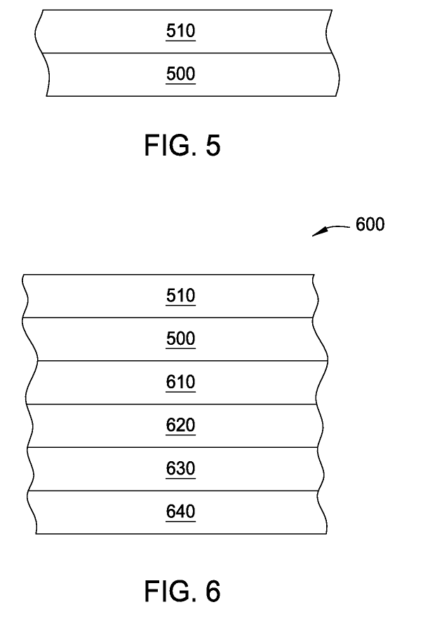

FIG. 5 is a schematic diagram illustrating one embodiment of a porous antireflective coating (ARC) 510 on a glass substrate 500 according to embodiments described herein. The porous antireflective coating 510 was produced using sol-gel compositions comprising the silane-based binder and silica based nanoparticles as described herein.

FIG. 6 is a schematic diagram illustrating one embodiment of a photovoltaic cell 600 comprising a porous antireflective coating formed from the sol-gel composition comprising the silane-based binder and silica based nanoparticles as described herein. The photovoltaic cell 600 comprises the glass substrate 500 and the porous antireflective coating as shown in FIG. 5. In this exemplary embodiment, the incoming or incident light from the sun or the like is first incident on the AR coating 510, passes therethrough and then through the glass substrate 500 and front transparent conductive electrode 610 before reaching the photovoltaic semiconductor (active film) 620 of the solar cell. The photovoltaic cell 600 may also include, but does not require, a reflection enhancement oxide and/or EVA film 630, and/or a back metallic or otherwise conductive contact and/or reflector 640 as shown in FIG. 6. Other types of photovoltaic devices may of course be used, and the photovoltaic device 600 is merely exemplary. As explained above, the AR coating 510 may reduce reflections of the incident light and permits more light to reach the thin film semiconductor film 620 of the photovoltaic device 600 thereby permitting the device to act more efficiently.

While the foregoing is directed to embodiments of the invention, other and further embodiments of the invention may be devised without departing from the basic scope thereof.

What is claimed is:

1. A method of forming a porous coating on a substrate, comprising:
coating a substrate with a sol formulation comprising:
a silane-based binder having one or more reactive groups; and
silica based nanoparticles, wherein the silane-based binder comprises from about 30 wt. % to about 70 wt. % ash contribution in the total ash content of the sol formulation; and
annealing the coated substrate.

2. The method of claim 1, wherein the total ash content of the sol formulation is from about 0.5 wt. % to 20 wt. % of the total wt. % of the sol formulation.

3. The method of claim 1, wherein the silane-based binder is selected from the group consisting of: tetraethylorthosilicate (TEOS), tetramethylorthosilicate, (TMOS), tetrapropylorthosilicate, methyltriethoxysilane (MTES), methylpropoxysilane, methyltrimethoxysilane (MTMS), glycidoxipropyltrimethoxysilane (Glymo), and combinations thereof.

4. The method of claim 1, further comprising:
forming a gel on the substrate by drying the sol formulation coated on the substrate prior to annealing the coated substrate.

5. The method of claim 1, wherein the silica based nanoparticles have a shape selected from spherical, elongated, disc-shaped, and combinations thereof.

6. The method of claim 5, wherein the silica based nanoparticles are selected from spherical particles having a particle size from about 40 to 50 nm, spherical particles having a particle size from about 70 to 100 nm, spherical particles having a particle size from about 10 to 15 nm, spherical particles having a particle size from about 17 to 23 nm, elongated particles having a diameter from 9 to 15 nm and length of 40 to 100 nm, and combinations thereof.

7. The method of claim 1, wherein the sol formulation further comprises:
an alcohol containing solvent; and
an acid or base containing catalyst.

8. The method of claim 7, wherein the silane-based binder is tetraethylorthosilicate (TEOS), the alcohol containing solvent is n-propyl alcohol (NPA), and the acid or base containing catalyst is acetic acid.

9. The method of claim 8, wherein the mass ratio of TEOS to silica based nanoparticles is between 60:40 and 90:10.

10. A porous coating formed by the process of:
coating a substrate with a sol-formulation comprising:
a silane-based binder having one or more reactive groups; and
silica based nanoparticles; and
forming a porous coating by annealing the coated substrate, wherein silica contribution from the silane-based binder comprises from about 30 wt. % to about 70 wt. % of the porous coating.

11. The porous coating of claim 10, wherein the silica based nanoparticles comprise from about 30 wt. % to about 70 wt. % of the porous coating.

12. The porous coating of claim 10, wherein the silane-based binder is selected from the group consisting of: tetraethylorthosilicate (TEOS), tetramethylorthosilicate, (TMOS), tetrapropylorthosilicate, methyltriethoxysilane (MTES), methylpropoxysilane, methyltrimethoxysilane (MTMS), glycidoxipropyltrimethoxysilane (Glymo), and combinations thereof.

13. The method of claim 10, wherein the sol-formulation further comprises:
an alcohol containing solvent; and
an acid or base containing catalyst.

14. The method of claim 10, wherein the silane-based binder is tetraethylorthosilicate (TEOS), the alcohol containing solvent is n-propyl alcohol (NPA), and the acid or base containing catalyst is acetic acid.

15. The method of claim 14, wherein the mass ratio of TEOS to silica based nanoparticles in the sol-formulation is between 60:40 and 90:10.

16. The porous coating of claim 10, having a pore fraction of between about 0.3 and 0.6 and a refractive index of less than 1.30.

17. A sol-formulation for forming a sol-gel, comprising:
an alcohol containing solvent;
an acid or base containing catalyst;
tetraethylorthosilicate (TEOS) binder; and
silica based nanoparticles, wherein the mass ratio of TEOS to silica based nanoparticles in the sol-formulation is between 60:40 and 90:10.

18. The sol-formulation of claim 17, wherein the alcohol containing solvent is n-propyl alcohol (NPA) and the acid or base containing catalyst is acetic acid.

19. The sol-formulation of claim 17, wherein the silica based nanoparticles have a shape selected from spherical, elongated, disc-shaped, and combinations thereof.

20. The sol-formulation of claim 19, wherein the silica based nanoparticles are selected from spherical particles having a particle size from about 40 to 50 nm, spherical particles having a particle size from about 70 to 100 nm, spherical particles having a particle size from about 10 to 15 nm, spherical particles having a particle size from about 17 to 23 nm, elongated particles having a diameter from 9 to 15 nm and length of 40 to 100 nm, and combinations thereof.
